(19) United States
(12) Patent Application Publication
(10) Pub. No.: US 2014/0253826 A1
(43) Pub. Date: Sep. 11, 2014

(54) TOUCH SCREEN AND MANUFACTURING METHOD THEREOF

(71) Applicant: Zhao He, Nanchang (CN)

(72) Inventor: Zhao He, Nanchang (CN)

(73) Assignee: NANCHANG O-FILM TECH. CO., LTD., Nachang (CN)

(21) Appl. No.: 13/985,996

(22) PCT Filed: Jul. 8, 2013
(86) PCT No.: PCT/CN2013/078974

§ 371 Date: Aug. 16, 2013

(30) Foreign Application Priority Data
Mar. 8, 2013 (CN) 201310074633.2

(51) Int. Cl. G06F 1/16

(52) U.S. Cl. CPC G06F 1/1643
USPC 349/12; 29/622

(57) ABSTRACT

A touch screen includes: a first transparent insulating substrate; a second transparent insulating substrate, comprising a first surface which is faced to the first transparent insulating substrate and a second surface opposite to the first surface; a sensing electrode layer, disposed between the first transparent insulating substrate and the second insulating substrate, the sensing electrode layer comprising a plurality of independently disposed sensing electrodes, each sensing electrode comprising a mesh-like conductive circuit; and a driving electrode layer, disposed on the first surface or the second surface of the second transparent insulating layer, the driving electrode layer comprising a plurality of independently disposed driving electrodes. A method of manufacturing a touch screen is also disclosed. The touch screen has a lower cost and a higher sensitivity.

### TECHNICAL FIELD

The present disclosure generally relates to a field of touch technology, and more particularly relates to a touch screen and a manufacturing method thereof.

### BACKGROUND

Touch screen is widely used in various kinds of electronic devices with screens, such as computers or electronic devices such as smart phone, TV, PDA, tablet PCs, notebook computers, machine tools with industrial touch screen, all-in-one computers and ultrabooks, etc. The touch screens fall into categories such as a capacitive touch screen, a resistive touch screen and a surface wave touch screen etc., according to a working principle thereof.

A capacitive touch screen relies on a current induced by a human body when the screen is touched. When a finger touches the touch screen, a coupling capacitor is produced between the finger and the surface of the capacitive touch screen due to a body electric field. For a high frequency current, the capacitor is a conductor, therefore, the fingers will siphon off a small current from the contact point of the touch screen. The current flows out from the electrodes located in four corners of the capacitive touch screen. And the current passing through each of the four electrodes is proportional to the distance between the finger and each of the four corners. The four current proportions are precisely calculated by a controller to derive a position of the touch point.

All current touch screens use ITO (indium tin oxide) glass or ITO film (i.e. ITO lay formed on the glass or on the film) to form patterns of driving electrodes and sensing electrodes. But the driving electrode and sensing electrode patterns formed on ITO glass or ITO films have the following disadvantages. First, the ITO driving electrode or sensing electrode bulges on the surface of the glass or transparent film, thereby tending to be scratched or peeled off, which would lead to reduction of the production yield. Second, a key material in ITO glass or ITO film is metal indium, which is rare and expensive. Furthermore, the resistance or the surface resistance of a large size touch screen made with ITO is large. This affects the signal transmission speed, which results in poor touch sensitivity. Poor touch sensitivity affects the functions of the electronic product, and leads to poor user experiences.

### SUMMARY

It is an object of the present disclosure to provide a touch screen with low cost and high sensitivity.

In addition, it is another object to provide a manufacturing method of a touch screen.

The present application discloses a touch screen that includes: a first transparent insulating substrate; a second transparent insulating substrate comprising a first surface facing the first transparent insulating substrate and a second surface opposite to the first surface; a sensing electrode layer disposed between the first transparent insulating substrate and the second insulating substrate, the sensing electrode layer comprises a plurality of independently disposed sensing electrodes, each sensing electrode comprises a mesh-like conductive circuit; and a driving electrode layer, disposed on the first surface or the second surface of the second transparent insulating layer, the driving electrode layer comprises a plurality of independently disposed driving electrodes.

The present application discloses a touch screen that includes: a rigid transparent insulating substrate; a sensing electrode layer, formed on a surface of the rigid transparent insulating substrate, the sensing electrode layer includes a plurality of independently disposed sensing electrodes, each sensing electrode of the sensing electrode layer comprises a mesh-like conductive circuit; a flexible transparent insulating substrate, comprising a first surface and a second surface which is opposite to the first surface, and a driving electrode layer, formed on the first surface or the second surface of the flexible transparent insulating substrate the sensing electrode layer comprising a plurality of independently disposed driving electrodes; the first surface or the second surface of the flexible transparent insulating substrate is attached to the rigid transparent insulating substrate.

A method of manufacturing a touch screen includes the following steps: providing a transparent insulating substrate; forming a sensing electrode layer on a surface of the first transparent insulating substrate; a sensing electrode of the sensing electrode layer is a mesh-like conductive circuit which comprises a plurality of mesh cells; providing a second transparent insulating substrate; forming a driving electrode layer on a surface of the second transparent insulating substrate; and attaching the second transparent insulating substrate to the first transparent insulating substrate.

A method of manufacturing a touch screen, includes the following steps: providing a first transparent insulating substrate; providing a second transparent insulating substrate; forming a driving electrode layer on one surface of the second transparent insulating substrate; forming a sensing electrode layer on the other surface of the second transparent insulating substrate; an electrode of the sensing electrode layer being a mesh-like conductive circuit comprising a large number of mesh cells; and attaching the first transparent insulating substrate to the second transparent insulating substrate.

Since in the methods and apparatus disclosed herein driving electrodes of the touch screen are manufactured onto a conductive mesh formed by the mesh-like conductive circuit, the touch screen does not have the above-described problems, such as that the surface is easy to be scratched or peeled off, the cost is high, the surface resistance is high for a large size screen when the ITO film is used. The advantages of the methods and apparatus disclosed herein include low manufacturing cost and high touch sensitivity of the touch screen.

### BRIEF DESCRIPTION OF THE DRAWINGS

FIG. 1 is a schematic view of an electronic device having a touch screen of the present disclosure.

FIG. 2 is a cross sectional view of a first type of class touch screens of the present disclosure.

FIG. 3 is a cross sectional view of an embodiment of FIG. 2.

FIG. 4 is a schematic plan view of a driving electrode layer of FIG. 3 forming a surface of a second transparent insulating layer.

FIG. 5 is a sectional view taken along the line a-a′ in FIG. 4.

FIG. 6 is a sectional view taken along the line b-b′ in FIG. 4.

FIG. 7 is a schematic plan view of a driving electrode layer of FIG. 3 forming a surface of a transparent insulating substrate.

FIG. 8 is a sectional view taken along the line A-A′ in FIG. 7.

FIG. 9 is a sectional view taken along the line B-B′ in FIG. 7.

FIG. 10 is a cross sectional view of a second type of class touch screens of the present disclosure.

FIG. 11 is a cross sectional view of a specific embodiment shown in FIG. 10.

FIG. 12 is a cross sectional view of a third type of class touch screens of the present disclosure.

FIG. 13 is a cross sectional view of a specific embodiment shown in FIG. 12.

FIG. 14 is a cross sectional view of a specific embodiment of fourth type of class touch screens of the present disclosure.

FIG. 15a and FIG. 15b are schematic views of arrangements and shapes of the sensing electrodes and driving electrodes.

FIG. 16a, FIG. 16b, FIG. 16c and FIG. 16d are partially enlarged views correspond to part A of FIG. 15a or part B of FIG. 15b respectively in accordance with one embodiment.

FIG. 17 is a flowchart of a method of manufacturing the touch screen in accordance with one embodiment.

FIG. 18 is a specific flowchart of step 102 of a process shown in FIG. 17.

FIG. 19 is a layered structure of the driving electrode layer obtained according to step 102 of a process shown in FIG. 17.

FIG. 20 is a flowchart of a method of manufacturing the touch screen in accordance with another embodiment.

FIG. 21 is a specific flowchart of step S204 of a process shown in FIG. 20.

### DETAILED DESCRIPTION OF THE EMBODIMENTS

Illustrative embodiments of the disclosure are described below. The following explanation provides specific details for a thorough understanding of and enabling description for these embodiments. One skilled in the art will understand that the disclosure may be practiced without such details. In other instances, well-known structures and functions have not been shown or described in detail to avoid unnecessarily obscuring the description of the embodiments.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,”“above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list.

The “transparent” described in the transparent insulating substrate of the present disclosure can be explained as “transparent” or “substantially transparent”; the insulating in the transparent insulating substrate can be explained as “insulating” or “dielectric”. So the “transparent insulating substrate” of the present invention can be explained as but not limited to transparent insulating substrate, substantially transparent insulating substrate, transparent dielectric substrate and substantially dielectric substrate.

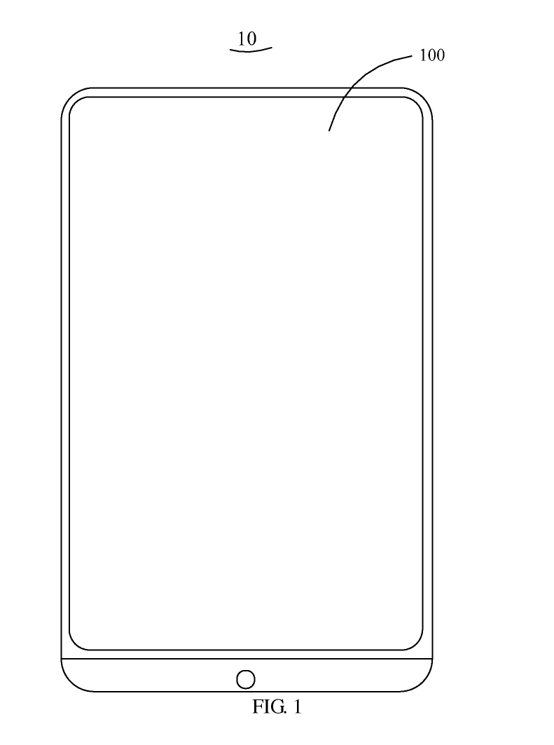

FIG. 1 shows one embodiment of an electronic device 10 having a touch screen of the present disclosure. The electronic device 10 may be a smart phone or a tablet PC. In the electronic device 10, the touch screen 100 is bonded to an upper surface of a LCD (Liquid Crystal Display) screen, which is used in one of I/O devices of an electronic device human computer interaction. It is to be understood that the touch screen 100 of the present disclosure can also be applied to electronic devices such as a mobile phone, a mobile communication phone, a TV, a tablet PC, a notebook computer, a machine tool with a touch display screen, a GPS equipment, an integrated computer and an ultra book.

Referring to FIG. 2, it is a cross-sectional view of the first type of class embodiments of the touch screen of the present disclosure. The touch screen 100 includes a first transparent insulating substrate 110, a sensing electrode layer 120, an adhesive layer 130, a driving electrode layer 140, and a second transparent insulating substrate 150. The sensing electrode layer 120 is located between the first transparent insulating substrate 110 and the second transparent insulating substrate 150. The second transparent insulating substrate 150 includes a first surface 152 which is faced to the first transparent insulating substrate 110, and a second surface 154 opposite to the first surface 152. The driving electrode layer 150 is formed on the first surface 152. In the alternative embodiments, the driving electrode layer 150 can also be disposed on the second surface 154.

The adhesive layer is used to bond the first transparent insulating substrate 110 and the second transparent insulating substrate 150 together. When the driving electrode layer 150 is disposed on the first surface 152, the adhesive layer 130 is used to insulate the sensing electrode layer 120 from the driving electrode layer 140. The adhesive layer can be a layer of optically transparent OCA (optical clear adhesive) or LOCA (liquid optical clear adhesive).

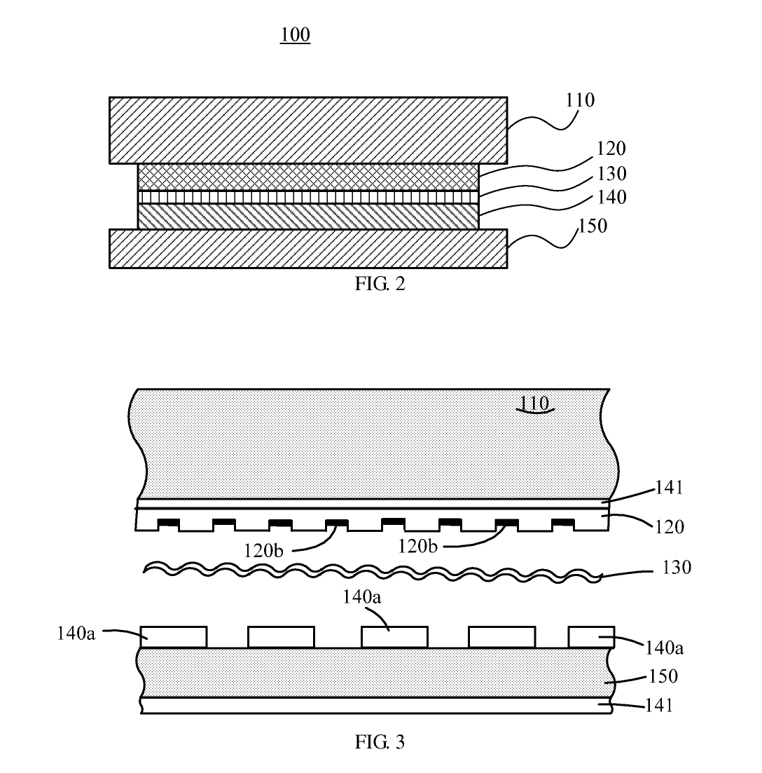

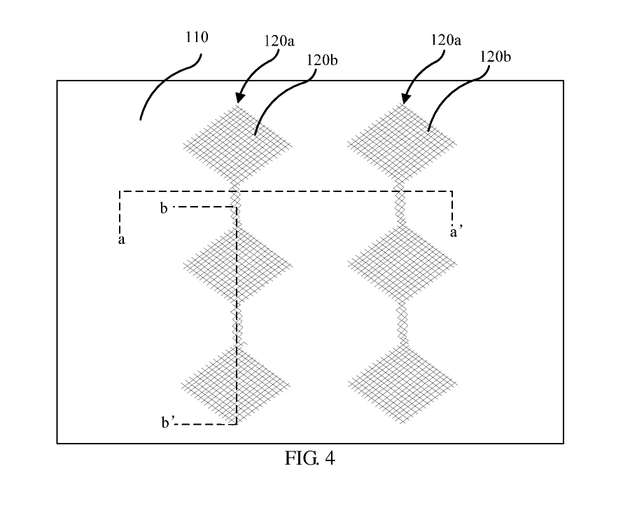

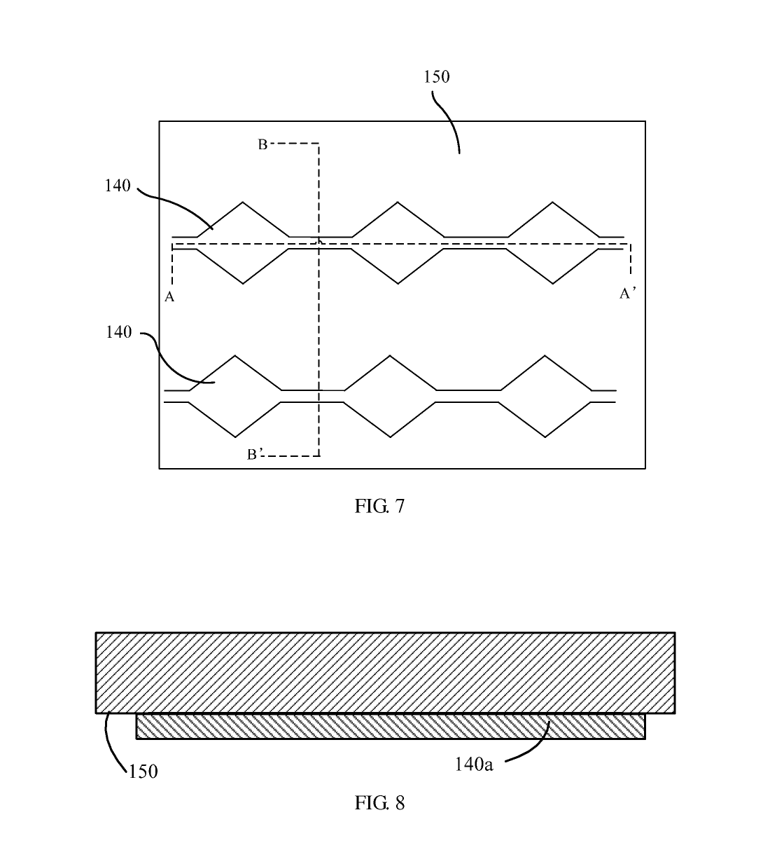

FIG. 3 is a cross sectional view of a first type of class touch screens in accordance with a specific embodiment. FIG. 4 is a plan view of the sensing electrode layer. The sensing electrode layer 120 includes a plurality of independently disposed sensing electrodes 120a. Referring also to FIG. 7, the driving electrode layer 140 includes a plurality of independently disposed driving electrodes 140a. “Independently disposed” described herein can be understood but not limit to several explanations of “independently disposed”, “spaced disposed” or “insulated disposed”.

In the capacitive touch screen, the sensing electrode and driving electrode are two essential parts of the touch sensing components. The sensing electrode is usually close to a touch surface of the touch screen, and the driving electrode is away from the touch surface. The driving electrode is connected to a scanning signal generating device. The scanning signal device provides a scanning signal, and the sensing electrode generates changed parameters when it is touched by a charged conductor to detect the touch position of the sensing region.

Each sensing electrode of the sensing electrode layer 120 is electrically connected to a peripheral sensing detection processing module of the touch screen, each driving electrode of the driving electrode layer 140 is electrically connected to the peripheral excitation signal module of the touch screen, and the sensing electrode and the driving electrode form a mutual capacitor therebetween. When a touch operation occurs on a surface of the touch screen, the mutual conductance of the touch center region will change, the touch operation is converted into an electrical signal, a coordinate data of the touch center region can be obtained by processing the data of the capacitance variation region, the electronic device which can process the related data obtains the corresponding exact position of the touch operation on a screen attached to the touch screen according to the coordinate of the touch center region, to complete the corresponding function and input operation.

In the illustrated embodiment, the sensing electrode layer 120 and the driving electrode layer 140 of the present disclosure are manufactured by different ways, different materials and different processes.

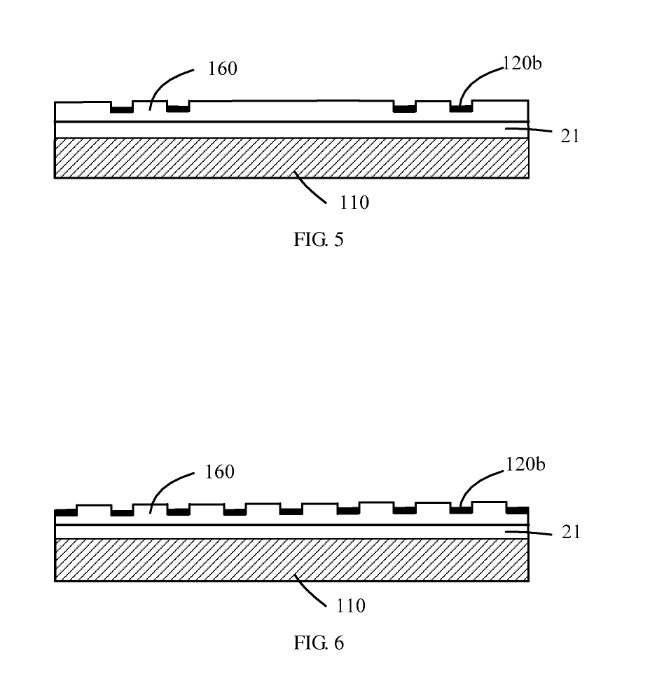

Specifically, both FIG. 5 and FIG. 6 are cross-sectional views taken along the lines of a-a′ and b-b′ respectively. The sensing electrode layer 120 includes a plurality of independently disposed mesh-like conductive circuits 120b. The mesh-like conductive circuit 120b is embedded or buried in the transparent insulating layer 160, the transparent insulating layer 160 is attached to a surface of the first transparent insulating substrate 110 by a tackifier layer 21. The mesh-like conductive circuit 120b is made of a material selected from a group consisting of gold, silver, copper, aluminum, zinc, gold-plated silver and alloys of at least two above metals. The above materials are low-cost and easy to procure. Moreover, the mesh-like conductive circuit 120b made of conductive silver paste has good conductivity and low cost.

It is easy to be understood that there are several ways that the mesh-like conductive circuit 120b is embedded or buried in the transparent insulating layer 160. In one exemplary embodiment, the transparent insulating layer 160 defines a plurality of interlaced mesh-like grooves, the mesh-like conductive circuit 120b is received in the groove, and the mesh-like conductive circuit 120b is embedded or buried in the surface of the transparent insulating layer 160. In a moving processor a handling process, because the sensing electrode 120a is firmly attached to the first transparent insulating substrate 110, the sensing electrode 120a is not easily damaged or peeled off. The mesh-like conductive circuit 120b can also be directly embedded or buried in a surface of the first transparent insulating substrate 110.

Specifically, a grid spacing of the meshed conductive circuit 120b is defined as d₁, and 100 μm≦d₁<600 μm, a surface resistance of the meshed conductive circuit 120b is defined as R, and 0.1 Ω/sq≦R<200 Ω/sq.

The surface resistance R of the meshed conductive circuit 120b affects the transmission speed of the current signal, thus affecting the responsiveness of the touch screen. Therefore, the surface resistance R of the meshed conductive circuit 120b is preferably defined as 1 Ω/sq≦R≦60 Ω/sq. The surface resistance R in this range can significantly increase the conductivity of the conductive film and significantly improve the signal transmission speed, and the accuracy requirement is lower compared to that of the surface resistance of 0.1 Ω/sq≦R<200 Ω/sq, the technical requirement is reduced to ensure conductivity. The cost is reduced as a result. It is to be understood in the manufacturing process, the surface resistance of meshed conductive circuit 120b (R) is determined by several factors, such as the grid spacing, material, traces diameter (traces width).

The mesh traces width of the meshed conductive circuit 120b is defined as d₂ and 1 μm≦d₂≦10 μm. The traces width of the mesh affects the transmittance of the conductive film, the smaller the traces width, the better the transmittance. When the grid spacing d₁ of the meshed conductive circuit is defined as 100 μm≦d₁<600 μm, the surface resistance R of the meshed conductive circuit 120b is defined as 0.1 Ω/sq≦R<200 Ω/sq, the mesh traces width d₂ is defined as 1 μm≦d₂≦10 μm which can satisfy the requirement, and can at the same time enhance the transmittance of the touch screen. Especially when the mesh traces width d₂ of the meshed conductive circuit 120b is defined as 2 μm≦d₂<5 μm, the larger the transmittance area, the better the transmittance, and the accuracy requirement is relatively low.

In an exemplary embodiment, the meshed conductive circuit 120b is made of silver, and uses a regular pattern. The grid spacing ranges from 200 μm to 500 μm; the surface resistance of the meshed conductive circuit 120b is defined as 4 Ω/sq≦R<50 Ω/sq, the coating amount of silver ranges from 0.7 g/m² to 1.1 g/m².

In a first embodiment, d₁=200 μm, R=4 to 5 Ω/sq, the silver amount is 1.1 g/m², the mesh traces width d₂ ranges from 500 nm to 5 μm. It is to be understood that the value of the surface resistance R and the amount of silver would be affected by the mesh traces width d₂ and filling groove depth. The larger the mesh traces width d₂, the larger the filling groove depth, the surface resistance would increase, the silver amount would also increase.

In a second embodiment, d₁=300 μm, R=10 Ω/sq, the silver amount ranges from 0.9 to 1.1 g/m², the mesh traces width d₂ ranges from 500 nm to 5 μm. It is to be understood, a value of the surface resistance R, an amount of the silver would be affected by the mesh traces width d₂ and filling groove depth, the larger the mesh traces width d₂, the larger the filling groove depth, the surface resistance would increase, the silver amount would also increase.

In a third embodiment, d₁=500 μm, R=30 to 40 Ω/sq, the silver amount is 0.7 g/m², the mesh traces width d₂ ranges from 500 nm to 5 μm. It is to be understood, a value of the surface resistance R, an amount of the silver would be affected by the mesh traces width d₂ and filling groove depth, the larger the mesh traces width d₂, the larger the filling groove depth, the surface resistance would increase; the silver amount would also increase.

It is to be understood, besides that the meshed conductive circuit 120b is made of metal conductive material, it can also be made of a material selected from a group consisting of transparent conductive polymers, carbon nanotubes and graphene.

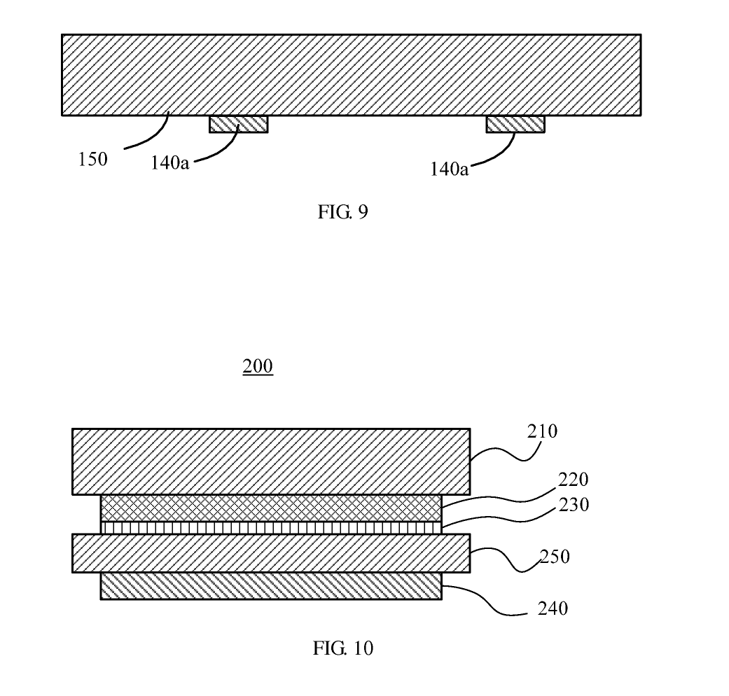

Referring to FIG. 7, FIG. 8 and FIG. 9, the driving electrode of the driving electrode layer 130 is made of a material selected from a group consisting of the ITO (Indium Tin Oxide), ATO (Antimony Doped Tin Oxide), IZO (Indium Zinc Oxide), AZO (Aluminum Zinc Oxide), PEDOT (Polyethylene Dioxythiophene), transparent conductive polymer, graphene and carbon nano tube. A patterned sensing electrode is formed by engineering processes of etching, printing, coating, lithography and photolithography, i.e. a plurality of independently disposed transparent sensing electrodes.

In the illustrated embodiment, the sensing electrode layer 130 is directly formed on a surface of the rigid transparent insulating substrate 110, and the rigid transparent insulating substrate 110 is a rigid substrate. Specifically, the rigid substrate uses strengthened glass or hardening transparent plastic plate, which is strengthened glass or reinforced plastic plate for short. The strengthened glass includes functional layers with functions of anti-glaring, hardening, antireflection or anti-fogging. The functional layer with functions of anti-glaring or anti-fogging is formed by coating paint with functions of anti-glaring or anti-fogging, the paint includes metal oxide particles; the functional layer with hardening function is formed by coating polymer paint with hardening function or by directly harden by a chemical or physical method; functional layer with antireflection function is a titania coating, a magnesium fluoride coating or a calcium fluoride coating. It is to be understood that a plastic plate with good transmittance can be manufactured to the rigid transparent substrate according to a processing method of the strengthened glass.

Referring to FIG. 3, the first transparent insulating substrate 110 is made of a flexible material, such as made of a material selected from a group consisting of flexible polyethylene terephthalate (PET), polycarbonate (PC), polyethylene (PE), polyvinyl chloride (PVC), polypropylene (PP), polystyrene (PS) or polymethyl methacrylate methyl ester (PMMA). Besides, in order to increase a adhesive strength of the of the first transparent insulating substrate 110, a surface of the first transparent insulating substrate 110 is provided with a tackifier layers 141, which facilitates a firmly attaching of the transparent insulating layer to the first transparent insulating substrate 110. Because the first transparent insulating substrate 110 is made of a flexible material, in a process of moving and handling, the flexible material may be deformed or bent. Using of an embedded or buried driving electrode is more reliable.

In one embodiment of the first type of class embodiments of the touch screen of the present disclosure, the first transparent insulating substrate 110 is made of plastics polyethylene terephthalate (PET), the second transparent insulating substrate 150 is made of strengthened glass, an ITO driving electrode layer is formed on the strengthened glass, the sensing electrode layer including a meshed conductive circuit is formed on a surface of the of the PET substrate, then a PET flexible substrate is attached to the second insulating substrate 150 made of strengthened glass, the flexible substrate is attached to the strengthened glass in a convenient way in the above embodiment to manufacture the touch screen of the present disclosure. The above manufacturing process is simple, and the thickness of the touch screen is reduced.

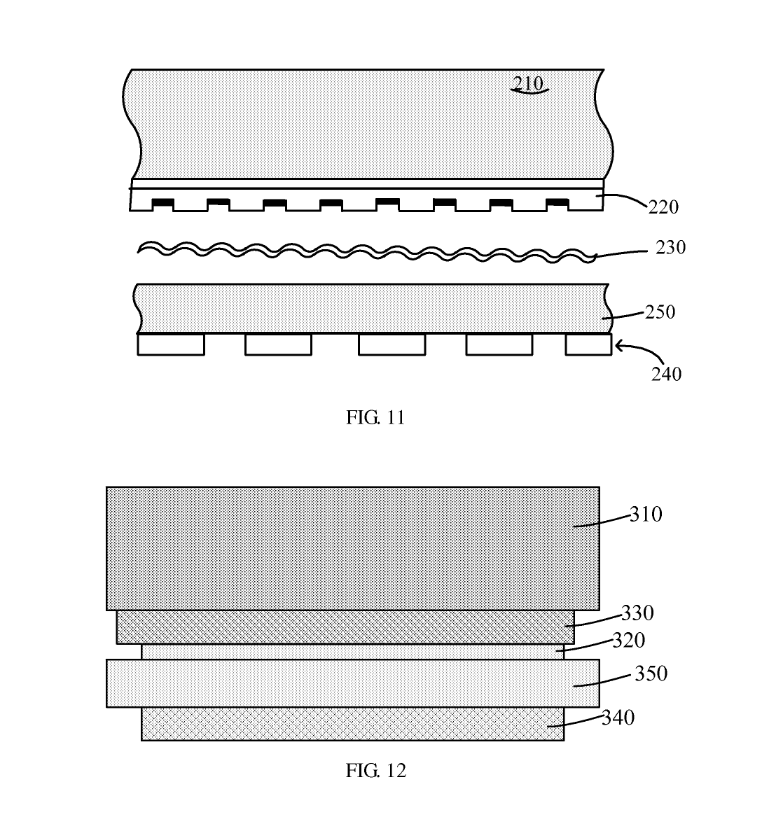

FIG. 10 and FIG. 11 show a cross sectional view of the second type of class touch screens and a cross sectional view of a specific embodiment respectively. The difference between the present type of class embodiments and the first type of class embodiments are: the driving electrode layer 240 is disposed on a second surface of the second transparent insulating substrate 250. In other word, compared to the first type of class touch screens, a back side of the second transparent insulating substrate 250 with the driving electrode layer 240 is attached to the first transparent insulating substrate 210 as one. Forming methods of the sensing electrode layer 220 and the driving electrode layer 240 are different from that of the first type of class embodiments.

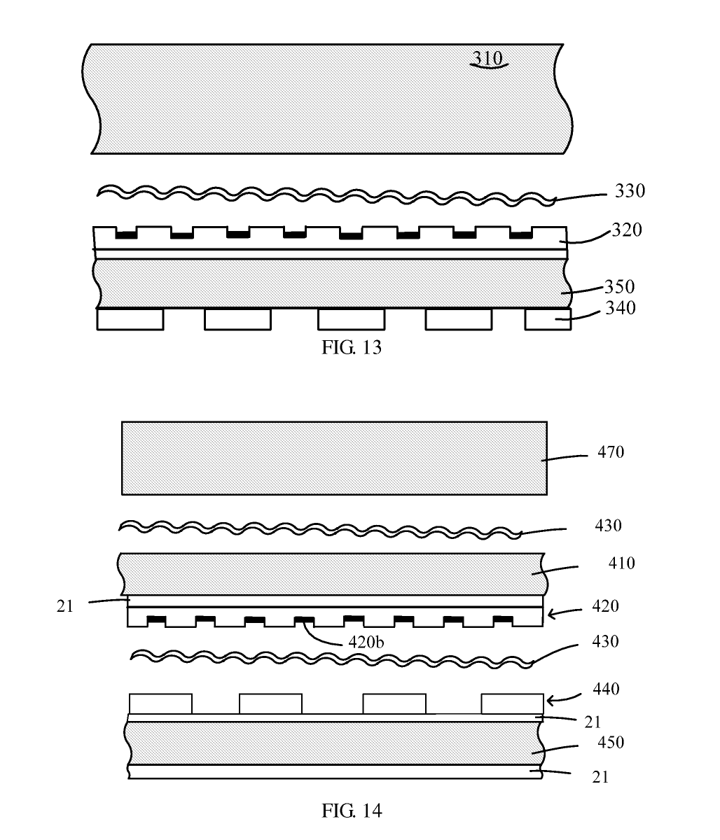

FIG. 12 and FIG. 13 show a cross sectional view of the touch screen of third type of class embodiments of the present disclosure and a cross sectional view of a specific embodiment respectively. Compared to the first type of class embodiments, the sensing electrode layer 320 is formed on the first surface of the second transparent insulating substrate 350, the driving electrode layer is formed on the second surface of the second transparent insulating substrate 350, i.e. it is a Dual ITO (DITO) structure. The driving electrode layer 340 includes a meshed conductive circuit 340b. The DITO structure is attached to the first transparent insulating substrate 310 by the adhesive layer 330. In the present type of class embodiments, the first transparent insulating substrate 310 is made of a material selected from a group consisting of strengthened glass, flexible polyethylene terephthalate (PET), polycarbonate (PC), polyethylene (PE), polyvinyl chloride (PVC), polypropylene (PP), polystyrene (PS) or poly methyl methacrylate (PMMA).

Referring to FIG. 14, it is a cross sectional view of fourth type of class embodiments of the present disclosure. The touch screen comprises a second transparent insulating substrate 450, a driving electrode layer 440, a adhesive layer 430, a sensing electrode layer 420, a first transparent insulating substrate 430 and a third transparent insulating substrate 470, all of which are sequentially stacked. The sensing electrode layer 420 is bonded to the first transparent insulating substrate 410 by the tackifier layer 21; the driving electrode layer 440 is bonded to the second transparent insulating substrate 450 by the tackifier layer 21. The sensing electrode layer 420 includes a meshed conductive circuit 420b. Compared to the above three type of classes of embodiments, the third transparent insulating substrate 470 is also included in the present type of class embodiments, the third transparent insulating substrate 470 is a strengthened glass plate or a flexible transparent plate. The flexible transparent plate is made of a material selected from a group consisting of flexible polyethylene terephthalate (PET), polycarbonate (PC), polyethylene (PE), polyvinyl chloride (PVC), polypropylene (PP), polystyrene (PS) or polymethyl methacrylate methyl ester (PMMA).

The differences between the present type of class embodiments and the above three type of classes of embodiments are: the first transparent insulating substrate 410 and the second transparent insulating substrate 450 are made of a material selected from a group consisting of strengthened glass, flexible polyethylene terephthalate (PET), polycarbonate (PC), polyethylene (PE), polyvinyl chloride (PVC), polypropylene (PP), polystyrene (PS) and polymethyl methacrylate methyl ester (PMMA). In a preferred embodiment, the first transparent insulating substrate 410 and the second transparent insulating substrate are flexible substrates, for example, made of PET.

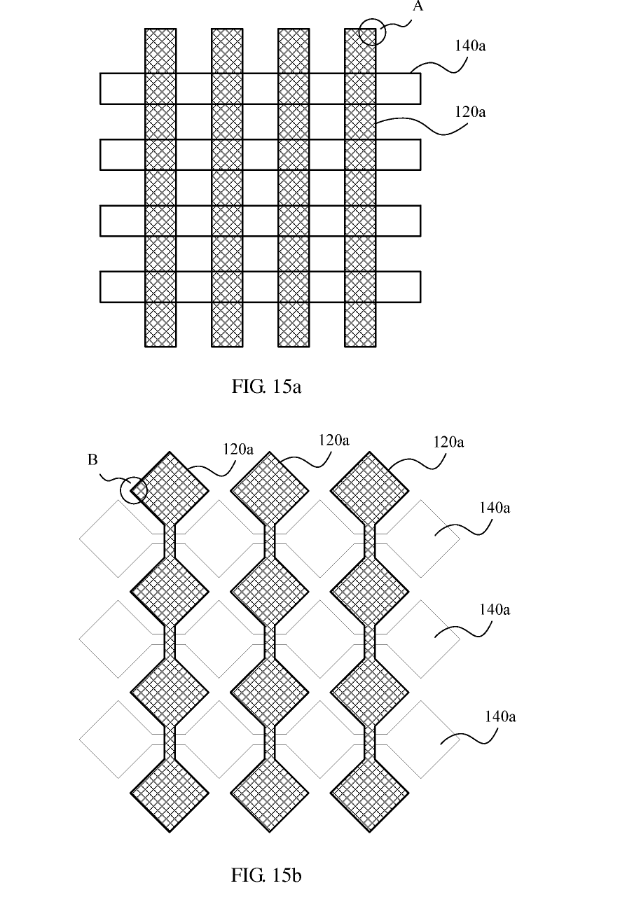

Referring to FIG. 15a and FIG. 15b, they are the schematic plan views of arrangements and shapes of the sensing electrode and driving electrode in accordance with several type of classes of embodiments of the present disclosure. The independently disposed sensing electrodes are parallel to the first axis (X axis) and disposed equally spaced; the independently disposed driving electrodes are parallel to the second axis (Y axis) and disposed equally spaced. The sensing electrode and driving electrode of FIG. 15a are shaped as bars and arranged interlacingly and perpendicular to each other; the sensing electrode and driving electrode of FIG. 15b are shaped as diamonds and arranged interlacingly and perpendicular to each other.

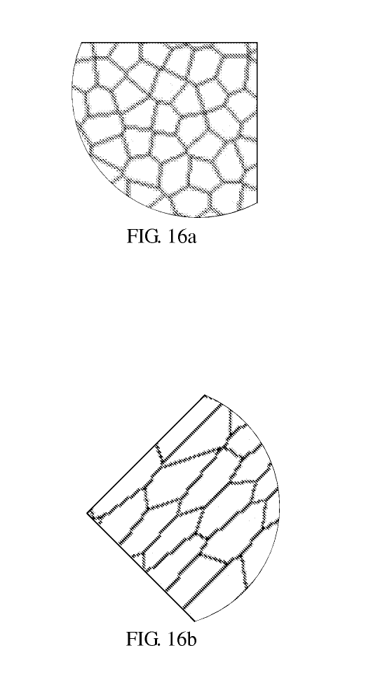

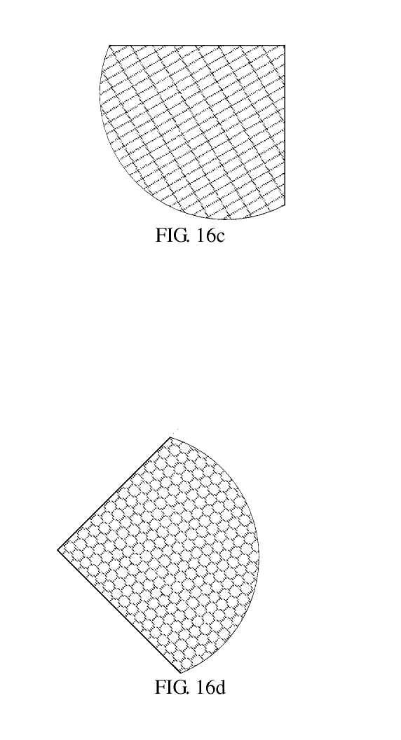

FIG. 16a, FIG. 16b, FIG. 16c and FIG. 16d are partially enlarged views correspond to part A of FIG. 15a or part B of FIG. 15b respectively in accordance with one embodiment.

The meshed conductive circuit in FIG. 16a and FIG. 16b is an irregular mesh; the manufacturing of the irregular meshed conductive circuit is simple, related processes are saved.

The meshed conductive circuit 120b of FIG. 16c and FIG. 16d is uniformly arranged in a regular pattern. The conductive mesh 11 is arranged uniformly and regularly, the grid spacing d₁ is equal. On one hand, it makes the transmittance of the touch screen uniform; on the other hand, the surface resistance of the mesh-like conductive circuit is distributed uniformly. Because the resistance deviation is small, the settings for correcting the resistance bias are not needed to make the image uniform. The conductive mesh can be substantially orthogonal straight line lattice patterns, curved wavy line lattice patterns. The mesh cell of the mesh-like conductive circuit can be a regular graph, such as triangle, diamond or regular polygon etc.; it can also be an irregular graph.

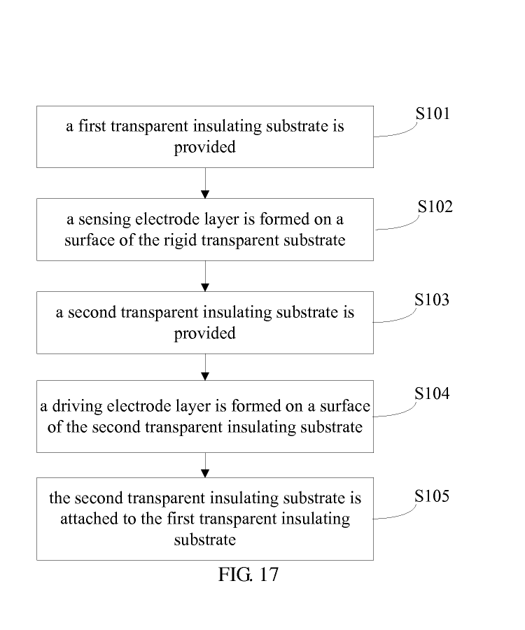

Referring to FIG. 17, it is a flowchart of the method of manufacturing a touch screen in accordance with one embodiment. Also referring to FIG. 3, the method includes the following steps.

Step S101: a first transparent insulating substrate is provided. The first transparent insulating substrate 110 is a rigid transparent insulating substrate or a flexible transparent insulating substrate; the rigid transparent insulating substrate can be the strengthened glass or flexible transparent cover lens. The flexible transparent cover lens is made of a material selected from a group consisting of the flexible polyethylene terephthalate (PET), polycarbonate (PC), polyethylene (PE), polyvinyl chloride (PVC), polypropylene (PP), polystyrene (PS) and polymethyl methacrylate acrylate (PMMA).

Step S102: a sensing electrode layer is formed on a surface of the rigid transparent substrate.

Step S103: a second transparent insulating substrate is provided. The second transparent insulating substrate 150 is a flexible transparent insulating substrate, it is made of a material selected from a group consisting of flexible polyethylene terephthalate (PET), polycarbonate (PC), polyethylene (PE), polyvinyl chloride (PVC), polypropylene (PP), polystyrene (PS) and polymethyl methacrylate methyl ester (PMMA). The second transparent insulating substrate 150 is a flexible thin film, it can be easily attached to the rigid first transparent insulating substrate 110.

Step S104: a driving electrode layer is formed on a surface of the second transparent insulating substrate.

There is no sequential order between the steps of S101 to S102 and between the steps of S103 to S104. It can be first to form the sensing electrode layer 120 on the first transparent insulating layer 140, it can also be first to form the driving electrode layer 140 on the second transparent insulating substrate 150. Alternatively, they can be done at the same time.

Step S105: the second transparent insulating substrate is attached to the first transparent insulating substrate.

A method of attachments shown in FIG. 3. A surface which is provided with the driving electrode layer 140 of the second transparent insulating substrate 150 is attached to a surface which is provided with the sensing electrode layer 120 of the first transparent insulating substrate 110. Alternatively, as shown in FIG. 11, a surface which is not provided with the driving electrode layer 240 of the second transparent insulating substrate 250 is attached to a surface which is provided with the sensing electrode layer 220 of the first transparent insulating substrate 210.

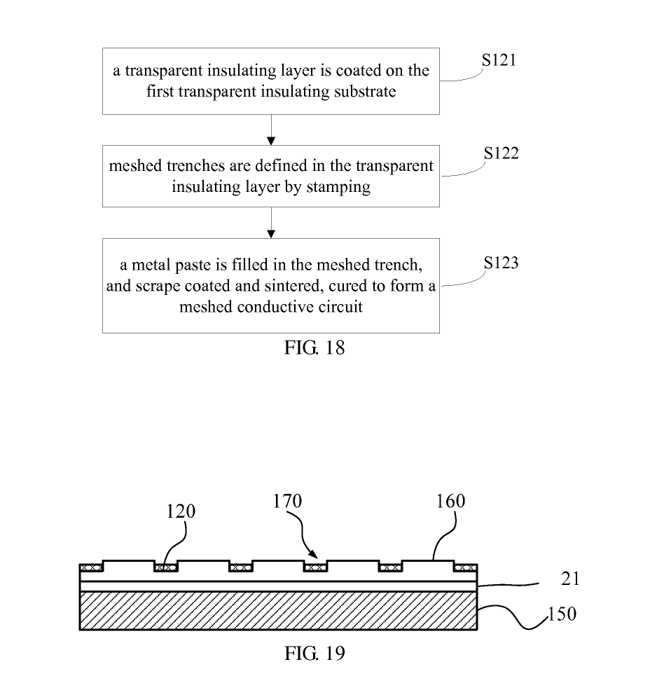

Referring to FIG. 18 and FIG. 19, the step S102 includes:

Step S121: a transparent insulating layer is coated on the first transparent insulating substrate. The transparent insulating layer is preferably a UV (ultraviolet) adhesive. In order to increase the adhesive strength of the UV adhesive and the first transparent insulating substrate, a tackifier layer 141 can be disposed between the first transparent insulating substrate 110 and the transparent insulating layer 160.

Step S122: mesh-like grooves are defined in the transparent insulating layer by stamping. Referring to FIG. 19, the transparent insulating layer 160 defines several mesh-like grooves 170 which have the same shape with the sensing electrode layer after mold pressing; the sensing electrode layer 120 is formed in the meshed groove 170.

Step S123: a metal paste is filled in the mesh-like groove, and scrape coated, and sintered, cured to form a mesh-like conductive circuit. The metal paste is filled in the mesh-like grooves 170, and scrape coated to make the mesh-like groove fill with the metal paste, and then it is sintered, cured to form a conductive mesh. The metal paste is preferably nano silver paste. In an alternative embodiment, the metal which forms the mesh-like conductive circuit can be one selected from a group consisting of gold, silver, copper, aluminum, zinc, gold-plated silver and alloys of at least two above metals.

In another embodiment, the mesh-like conductive circuit can also be manufactured by other process, for example, the mesh-like conductive circuit of the present disclosure is manufactured by photolithography.

Furthermore, referring to FIG. 14, the transparent cover lens 470 can also be formed on the first transparent insulating substrate 410. The transparent screen 470 can be a strengthened glass plate or a flexible transparent plate.

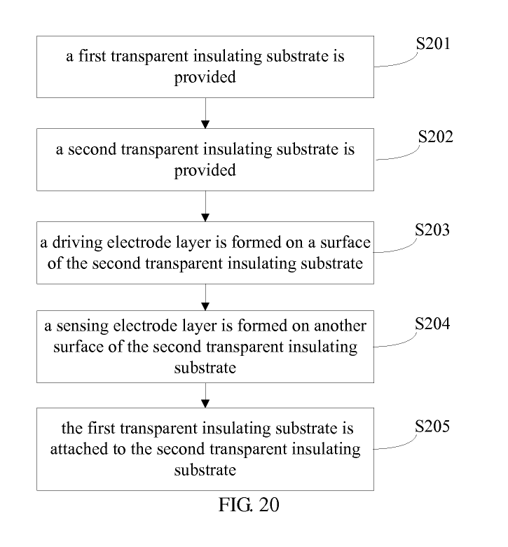

Referring to FIG. 20, it is a flowchart of a method of manufacturing the touch screen in accordance with another embodiment. Referring also to FIG. 13, the method includes the following steps.

Step S201: a first transparent insulating substrate is provided. The first transparent insulating substrate 310 is a rigid transparent insulating substrate or a flexible transparent insulating substrate; the rigid transparent insulating substrate can be a strengthened glass plate or flexible transparent cover lens. The flexible transparent cover lens is made of a material selected from a group consisting of the flexible polyethylene terephthalate (PET), polycarbonate (PC), polyethylene (PE), polyvinyl chloride (PVC), polypropylene (PP), polystyrene (PS) and polymethyl methacrylate acrylate (PMMA).

Step S202: a second transparent insulating substrate is provided. The second transparent insulating substrate 350 is a flexible transparent insulating substrate,made of a material selected from a group consisting of flexible polyethylene terephthalate (PET), polycarbonate (PC), polyethylene (PE), polyvinyl chloride (PVC), polypropylene (PP), polystyrene (PS) and polymethyl methacrylate methyl ester (PMMA). The second transparent insulating substrate 350 is a flexible thin film, and it can be easily attached to the first transparent insulating substrate 310.

Step S203: a driving electrode layer is formed on a surface of the second transparent insulating substrate.

Step S204: a sensing electrode layer is formed on another surface of the second transparent insulating substrate.

The sequence between step S203 and step S204 is arbitrary. It can first form the sensing electrode layer 320 on the first transparent insulating layer 140, it can also form the driving electrode layer 340 on the second transparent insulating substrate 350 first.

Step S205: the first transparent insulating substrate is attached to the second transparent insulating substrate.

The way of attachment may be that the first transparent insulating substrate 310 is attached to a surface which is not provided with the sensing electrode layer 320 of the second transparent insulating substrate 350.

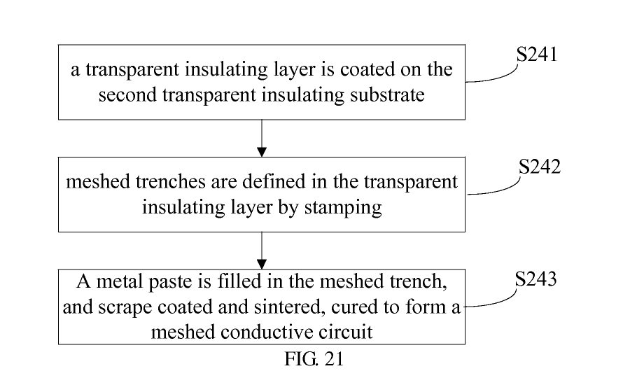

Referring to FIG. 19 to FIG. 21, the step S204 specifically includes:

Step S241: a transparent insulating layer is coated on the second transparent insulating substrate. The transparent insulating layer 160 is preferably a UV (ultraviolet) adhesive. In order to increase the adhesive strength of the UV adhesive and the flexible insulating substrate, a tackifier layer can be disposed between the second transparent insulating substrate 150 and the transparent insulating layer 160.

Step S242: mesh-like grooves are defined in the transparent insulating layer by stamping. Referring to FIG. 19, the transparent insulating layer 160 defines several mesh-like grooves 170 which have the same shape as the sensing electrode after mold pressing; the sensing electrode layer 120 is formed in the mesh-like grooves 170.

Step S243: a metal paste is filled in the mesh-like grooves, and scrape coated and sintered, cured to form a mesh-like conductive circuit. The metal paste is added in the mesh-like grooves 170, and scrape coated to make the mesh-like grooves fill with the metal paste, and then it is sintered, cured to form a conductive mesh. The metal paste is preferably nano silver paste. In alternative embodiments, the metal that forms the mesh-like conductive circuit can be one selected from a group consisting of gold, silver, copper, aluminum, zinc, gold-plated silver and alloys of at least two above metals.

In some embodiments, the mesh-like conductive circuit can also be manufactured by other process, for example, the mesh-like conductive circuit of the present disclosure is manufactured by photolithography.

Furthermore, it can also be that the transparent cover lens is formed on the first transparent insulating substrate. The transparent cover lens can be a strengthened glass plate or a flexible transparent cover lens.

The driving electrode of the touch screen is manufactured to the conductive mesh formed by the mesh-like conductive circuit in the above method, the touch screen does not have the problems such as the surface is easy to be scratched or peeled off, the cost is high, the surface resistance is high for the large size screen when the ITO film is used. Therefore the cost of the touch screen is low and the sensitivity is higher.

Although the present disclosure has been described with reference to the embodiments thereof and the best modes for carrying out the present disclosure, it is apparent to those skilled in the art that a variety of modifications and changes may be made without departing from the scope of the present disclosure, which is intended to be defined by the appended claims.

What is claimed is:

1. A touch screen, comprising:
a first transparent insulating substrate;
a second transparent insulating substrate comprising a first surface facing the first transparent insulating substrate and a second surface opposite to the first surface;
a sensing electrode layer disposed between the first transparent insulating substrate and the second insulating substrate, the sensing electrode layer comprising a plurality of spaced sensing electrodes, each sensing electrode comprising a mesh-like conductive circuit; and
a driving electrode layer disposed on the first surface or the second surface of the second transparent insulating layer, the driving electrode layer comprising a plurality of spaced driving electrodes.

2. The touch screen according to claim 1, wherein a grid spacing of the mesh-like conductive circuit is defined as d₁, and 100 μm≦d₁<600 μm; a surface resistance of the mesh-like conductive circuit is defined as R, and 0.1 Ω/sq≦R<200 Ω/sq.

3. The touch screen according to claim 1, further comprising a third transparent insulating layer formed on a surface of the first transparent insulating substrate, wherein the mesh-like conductive circuit is embedded or buried in the transparent insulating layer.

4. The touch screen according to claim 3, wherein the third transparent insulating layer defines a plurality of interlaced mesh-like grooves, the mesh-like conductive circuit is received in the meshed grooves.

5. The touch screen according to claim 1, wherein the first transparent insulating substrate is a rigid substrate, the second transparent insulating substrate is a flexible substrate.

6. The touch screen according to claim 5, wherein the first rigid transparent insulating substrate is a strengthened glass, the second flexible transparent insulating substrate is made of a material selected from a group consisting of polyethylene terephthalate, polycarbonate, polyethylene, polyvinyl chloride, polypropylene, polystyrene and polymethyl methacrylate.

7. The touch screen according to claim 1, wherein the first transparent insulating substrate is a flexible substrate, the second transparent insulating substrate is a rigid substrate or a flexible substrate.

8. The touch screen according to claim 7, further comprising a transparent cover lens attached to a surface of the first transparent insulating substrate.

9. The touch screen according to claim 8, wherein the transparent cover lens is a strengthened glass panel or a flexible transparent panel.

10. The touch screen according to claim 1, further comprising an adhesive layer, wherein the adhesive layer is arranged between the first transparent insulating substrate and the second transparent insulating substrate.

11. The touch screen according to claim 10, wherein the adhesive layer is a layer of optically transparent optical clear adhesive (OCA) or liquid optical clear adhesive (LOCA).

12. The touch screen according to claim 1, wherein the sensing electrode layer is made of a material selected from a group consisting of indium tin oxide, antimony tin oxide, indium zinc oxide, zinc aluminum and polyethylene dioxythiophene.

13. The touch screen according to claim 1, wherein grids of the mesh-like conductive circuit are regular in shape.

14. The touch screen according to claim 1, wherein grids of the mesh-like conductive circuit are irregular in shape.

15. The touch screen according to claim 1, wherein the mesh-like conductive circuit is made of silver, a grid spacing of the mesh-like conductive circuit ranges from 200 μm to 500 μm; a surface resistance of the mesh-like conductive circuit is defined as R, and 4 Ω/sq≦R<50 Ω/sq, a coating amount of silver ranges from 0.7 g/m² to 1.1 g/m².

16. The touch screen according to claim 1, wherein the mesh-like conductive circuit is made of a material selected from a group consisting of gold, silver, copper, aluminum, zinc, gold-plated silver and alloys of at least two above metals.

17. The touch screen according to claim 3, wherein the transparent insulating layer can be formed by curing a light curing glue, thermosetting adhesive or air-drying adhesive.

18. A touch screen, comprising:
a rigid transparent insulating substrate;
a sensing electrode layer, formed on a surface of the rigid transparent insulating substrate, the sensing electrode layer comprising a plurality of independently disposed sensing electrodes, each sensing electrode of the sensing electrode layer comprising a mesh-like conductive circuit;
a flexible transparent insulating substrate, comprising a first surface and a second surface opposite to the first surface, and
a driving electrode layer, formed on the first surface or the second surface of the flexible transparent insulating substrate, the sensing electrode layer comprising a plurality of independently disposed driving electrodes;
wherein the first surface or the second surface of the flexible transparent insulating substrate is attached to the rigid transparent insulating substrate.

19. The touch screen according to claim 18, wherein a grid spacing of the mesh-like conductive circuit is defined as d₁, and 100 μm≦d₁<600 μm, and wherein a surface resistance of the mesh-like conductive circuit is defined as R, and 0.1 Ω/sq≦R<200 Ω/sq.

20. The touch screen according to claim 18, further comprising a transparent insulating layer formed on a surface of the flexible transparent insulating substrate, the mesh-like conductive circuit is embedded or buried in the transparent insulating layer.

21. The touch screen according to claim 20, wherein the transparent insulating layer defines a plurality of interlaced mesh-like groove, and wherein the mesh-like conductive circuit is received in the mesh-like groove.

22. The touch screen according to claim 18, wherein the rigid transparent insulating substrate is a strengthened glass, the flexible transparent insulating substrate is made of a material selected from a group consisting of flexible polyethylene terephthalate, polycarbonate, polyethylene, polyvinyl chloride, polypropylene, polystyrene and polymethyl methacrylate

23. The touch screen according to claim 18, wherein the sensing electrode is made of transparent indium tin oxide.

24. The touch screen according to claim 18, wherein grids of the mesh-like conductive circuit are regular in shape.

25. The touch screen according to claim 18, wherein grids of the mesh-like conductive circuit are irregular in shape.

26. The touch screen according to claim 24, wherein a cell of the mesh is a single triangle, diamond or regular polygon.

27. A method of manufacturing a touch screen, comprising the following steps:
providing a first transparent insulating substrate;
forming a sensing electrode layer on a surface of the first transparent insulating substrate; a sensing electrode of the sensing electrode layer is a mesh-like conductive circuit which comprises a plurality of mesh cells;
providing a second transparent insulating substrate;
forming a driving electrode layer on a surface of the second transparent insulating substrate; and
attaching the second transparent insulating substrate to the first transparent insulating substrate.

28. The method according to claim 27, wherein the formation of the sensing electrode layer on a surface of the first transparent insulating substrate comprises:
coating a transparent insulating layer on the first transparent insulating substrate;
defining a mesh-like groove on the transparent insulating layer by stamping;
forming a mesh-like conductive circuit in the mesh-like groove.

29. The method according to claim 28, wherein the formation of the mesh-like conductive circuit in the mesh-like groove comprises:
filling a metal paste to the mesh-like groove; and
scrape coating, sintering and curing the metal paste.

30. The method according to claim 27, wherein the step of attaching the second transparent insulating substrate to the first transparent insulating substrate comprises:
attaching a surface forming with the driving electrode layer of the second transparent insulating substrate to a surface forming with the sensing electrode layer of the first transparent insulating substrate; or
attaching a surface forming without the driving electrode layer of the second transparent insulating substrate to a surface forming with the sensing electrode layer of the first transparent insulating substrate.

31. The method according to claim 27, further comprising forming a transparent cover lens on a surface of the first transparent insulating substrate.

32. The method according to claim 31, wherein the transparent cover lens is a strengthened glass screen or a flexible transparent cover lens.

33. A method of manufacturing a touch screen, comprising the following steps:
providing a first transparent insulating substrate;
providing a second transparent insulating substrate;
forming a driving electrode layer on one surface of the second transparent insulating substrate;
forming a sensing electrode layer on the other surface of the second transparent insulating substrate, an electrode of the sensing electrode layer being a mesh-like conductive circuit comprising a large number of mesh cells; and
attaching the first transparent insulating substrate to the second transparent insulating substrate.

34. The method according to claim 33, wherein the formation of the sensing electrode layer on the other surface of the first transparent insulating substrate comprises:
coating a transparent insulating layer on the second transparent insulating substrate;
defining a mesh-like groove on the transparent insulating layer by stamping; and
forming the mesh-like conductive circuit in the mesh-like groove.

35. The method according to claim 34, wherein the formation of the mesh-like conductive circuit in the mesh-like groove comprises:
filling a metal paste to the mesh-like groove; and
scrape coating, sintering and curing the metal paste.

36. The method according to claim 33, the step of attaching the first transparent insulating substrate to the second transparent insulating substrate comprises attaching the first transparent insulating substrate to a surface forming the sensing electrode layer of the first transparent insulating substrate.

37. The method according to claim 33, further comprising forming a transparent cover lens on a surface of the first transparent insulating substrate.

38. The method according to claim 37, wherein the transparent cover lens is a strengthened glass screen or a flexible transparent cover lens.
